(19) United States
(12) Patent Application Publication
(10) Pub. No.: US 2023/0410847 A1
(43) Pub. Date: Dec. 21, 2023

(54) Shared Digital Environment for Music Production, Creation, Sharing and the Like

(71) Applicant: GROUPE BEATCONNECT INC., Beaconsfield (CA)

(72) Inventors: Alexandre Turbide, Beaconsfield (CA); Nicolas Laroche, Longueuil (CA)

(21) Appl. No.: 18/251,622

(22) PCT Filed: Jan. 13, 2022
(86) PCT No.: PCT/CA2022/050047

§ 371 Date: May 3, 2023

Related U.S. Application Data
(60) Provisional application No. 63/143,090, filed on Jan. 29, 2021.

(51) Int. Cl. G11B 27/028; H04L 65/611

(52) U.S. Cl. CPC G11B 27/028; H04L 65/611

(57) ABSTRACT

A method for connecting a plurality of remotely located users over a shared environment. The method includes the steps of loading, by a first user, a first data sample to a shared sequencer, which is converted to a base64 string. The base64 string is part of a JUCE library code. The converted first data sample is converted to a compressed data sample and a plurality of messages is converted by splitting the compressed data sample into 65k byte chunks having therein a portion of metadata. The messages are prioritized from low priority to high priority and queued for sorting. Finally, the sorted messages are sent to a server. The server has a defined studio identification. The server routes the sorted messages to the studio for caching. The cached messages are added to one or more of the remotely located second users' message queues.

### TECHNICAL FIELD

The present generally concerns real-time co-creative shared digital environment for music creation, music production, music collaboration and music sharing.

### BACKGROUND

Digital Audio Workstation (DAW)s are the cornerstone of the digital music industry as they're essential to record, edit and produce audio tracks. Even though the market is mature, it's still somewhat fragmented with over a dozen players fiercely competing. At the top of the DAW pyramid stands Ableton, the industry leader with 20.52% of the market. With the top 4 DAW providers holding just over 66% of the market, the rest of the players must constantly innovate with small inexpensive features and functionalities to try and stand out of the pack. This fragmentation quickly becomes a problem when designing any collaborative tool or platform as users are very likely to be using different DAWs. While all DAWs serve the same basic functions, they all work slightly differently (different plug-in protocols, different audio and Musical Instrument Digital Interface (MIDI) routing, Voltage Controlled Amplifier (VCA) grouping, etc.) resulting in severe file interchangeability issues.

Even with different versions of the same DAW ‘family’, you may find that an ‘LE’ or ‘lite’ version can't open a project created in the ‘full-fat’ product, simply because the full version includes functionalities that are missing or disabled in others. Newer versions of a DAW may include additional functionality, and different plug-ins from previous versions, as plug-ins have been updated, or licensing deals with third-party suppliers of older plug-ins expire.

This technological roadblock has become the main barrier to entry for any company that wishes to develop a collaborative tool, and in fact has created two separate markets; DAW integrated tools and file sharing platforms.

Generally speaking, there are two ways in which the above problem can be tackled;

Firstly, by building a solution through the DAW is faced with a big limitation; collaboration with other music producers is very complicated. In fact, unless all participants use a similar enough version of the same DAW, and with exactly the same plugins, it is difficult to collaborate with MIDI files (It's possible to share midi files, but to render the midi files accurately requires the exact same vsti(s) and vst(s), as well as DAW mixer settings (gain, panning)). These weaknesses are mostly caused by the format in which the audio tracks are generated. Ableton is the leading DAW provider with just over 20% of the market, but their collaborative ecosystem for music producers is limited to that 20% as it doesn't work with other DAWs. Since the DAW market is fragmented with over 12 players sharing 85% of the market, and the leader sitting at 20%, there is a very strong possibility that 2 players will not be sharing the same production environment.

Secondly, by building a solution through a plugin is the easiest way to approach the collaborative problem since it's cheap to develop and can break artificial boundaries set by DAWs to keep their ecosystems closed. However, many currently available solutions suffer from a number of disadvantages and drawbacks. Firstly, and most importantly, they don't create a collaborative environment where all participants can interact at the same time. Technically speaking, all solutions focus on creating a master-slave relationship between two computers where sound can be relayed from DAW “A” to DAW “B”. This means that only the user producing the song can control the outcome of the song being created. All other participants are merely playing instruments in a vacuum. Interactions between multiple users in a shared digital environment is extremely complex as all input and output of information need to be properly prioritized and transmitted (whether it be related to music tracks and sounds, or user interactions such as increasing or lowering the volume). Secondly, they don't offer cross-platform compatibility. Not all plugins will work across all DAWs and Operating Systems (OS). As previously mentioned, it's not just a matter of using the proper plugin extension, anything shared between 2 users must have a similar sample rate. The solutions on the market don't account for difference in sample rates for the song being shared and often need to be manually modified by the users. The sample rate difference between the destination user (the user received the information), and the one sending the sound needs to be accounted for and corrected. Finally, “real-time”collaboration is currently defined as playing music simultaneously with another user through an audio (and sometimes video) interface, which doesn't account for the different creative dynamics that comes with remote collaboration. This type of real-time collaboration could be defined as “synchronous” collaboration, where all users are hearing and playing together in a live setting. By focusing their effort on this form synchronous real-time collaboration, the main differentiator between all the solutions on the market is the latency (the time it takes for the information to travel between user 1 and user 2). Any amount of latency can impact the quality of a remote live recording, hence why many of these products have failed in the past.

Audiomover's Listento™ plug-in is a post-production audio streaming tool that was released in 2017. It became popular with music producers specifically for its ease of use and compatibility. By connecting the output of the DAW directly to the Listento plug-in, the audio is sent to a website where anyone can connect. Its most common use case is for producers to complete the mixing and stream the song directly to the website where the musicians would share their feedback. This real-time back and forth, while not optimal, is considerably faster than sharing the song through email or cloud services.

Source-Elements' Source-Connect™ is a replacement to ISDN (integrated services digital network) within the music industry and is considered top of the line in term of remote audio and sound recording. It distinguishes itself by boasting a solid set of features that allow audio and sound professionals to undertake several aspects common in the audio post-production industry such as overdub, ADR and voice-over. Source-Connect works as a standalone application and doesn't require DAW integration. It can establish two-way connections between any DAW, plug-in, or recording system, making it a very versatile product.

Sessionwire™ is a standalone application that connects to your DAW by creating a virtual soundcard which you can link to a track within the DAW. It currently supports 2 users per session and has video-chat capabilities. Once a connection is established between 2 users, and Sessionwire™ is properly setup with their respective DAWs, tracks can be dragged and drop in the Sessionwire™ interface to transfer tracks. All tracks need to be downloaded on the receiving end and manually placed within a track in the DAW before being usable.

However, none of the above platforms sufficiently address the need for real-time collaboration. No DAW integrated tool currently available allows for collaborative (or synchronous) editing, mixing, looping or sequencing of audio tracks. On the other hand, file sharing platforms are nothing more than lesser versions of Google DocT as even the most popular platforms don't allow for more than one person to edit a project at a time.

Thus, we determined there was an unmet need to develop a platform that would be compatible across the vast majority of DAWs while also being more than just an audio-streaming tool.

### BRIEF SUMMARY

We have significantly reduced, or essentially eliminated, the problems of contemporary platforms by inventing a hub that can either integrate directly as a plugin with any DAW or as a standalone platform for musicians that want a simpler experience. In both cases, the hub establishes a real-time connection through its interface where multiple players can share and play together. Within this interface any track recorded from the user's DAW or audio input will instantly be converted into a generic audio format compatible across any DAW. Advantageously, this process is seamless and allows for all parties to edit and mix track in the collaborative environment. As noted above, most collaborative tools currently available are designed for use by professionals and therefore cater to a very specific niche within the market. As such, these tools focus on channeling sounds and effects from one “slave” computer to a “master” computer, essentially making any collaborative experience a one-way street. Only the “master” computer can dictate the outcome of the project has he's responsible for the editing, looping, and sequencing of the various tracks. In all of those cases, collaboration is limited to two users. Our platform is accessible and usable by a plurality of users in real time.

Accordingly, in a first embodiment there is provided a method for connecting a plurality of remotely located users over a shared environment, the method comprising:
loading, by a first user, a first data sample to a shared sequencer;
converting the first data sample to a base64 string, the base64 string being part of a JUCE library code;
converting the converted first data sample to a compressed data sample;
generating a plurality of messages by splitting the compressed data sample into 65k byte chunks having therein a portion of metadata;
prioritizing the messages from low priority to high priority and queuing the prioritized messages for sorting; and
sending the sorted messages to a server, the server having a defined studio identification, the server routing the sorted messages to the studio for caching, the cached messages being added to one or more of the remotely located second users' message queue.

In on example, the method further includes: at least one destination user sequentially receives portions of the 65k byte chunks, the chunks being reconstructed. The destination user verifies sound sample rate by comparing the sound sample rate to a predefined sound card sample rate; and if required, correcting the sample rate. The method further includes: creating a temporary way file by dragging the reconstructed sample outside one or more Digital Audio Workstations (DAW)s. A network of the DAWs, creating tracks that are compatible by capturing audio output therefrom and converting sample rate and tempo.

In one example, music sessions are created synchronously and asynchronously either when the first user is alone or in remote or close location with the plurality of second users. The users are musicians.

In another example, the first user shares information and sounds for distribution to one or more second users in real time.

In yet another example, the reconstructed sample is saved on a remote memory. The remote memory is the cloud.

In still another example, up to five users are connected in real time.

In one example, the 65k byte chunk s includes about 1/20 of the original size.

Accordingly, in a second embodiment there is provided one or more non-transitory computer-readable storage media encoding computer executable instructions which, when executed by at least one processor, performs a method for connecting a plurality of remotely located users over a shared environment, the method comprising:
initiating a first computing device and loading, by a first user, a first data sample to a shared sequencer;
converting the first data sample to a base64 string, the base64 string being part of a JUCE library code;
converting the converted first data sample to a compressed data sample;
generating a plurality of messages by splitting the compressed data sample into 65k byte chunks having therein a portion of metadata;
prioritizing the messages from low priority to high priority and queuing the prioritized messages for sorting; and
sending the sorted messages to a server, the server having a defined studio identification at a second computing device, the server routing the sorted messages to the studio for caching, the cached messages being added to one or more of the remotely located second users' message queues.

Accordingly, in a third embodiment there is provided a system comprising: one or more processors; and a memory coupled to the one or more processors, the memory for storing instructions which, when executed by the one or more processors, cause the one or more processors to perform a method for connecting a plurality of remotely located users over a shared environment, the method comprising, the method comprising:
initiating a first computing device and loading, by a first user, a first data sample to a shared sequencer;
converting the first data sample to a base64 string, the base64 string being part of a JUCE library code;
converting the converted first data sample to a compressed data sample;
generating a plurality of messages by splitting the compressed data sample into 65k byte chunks having therein a portion of metadata;
prioritizing the messages from low priority to high priority and queuing the prioritized messages for sorting; and
sending the sorted messages to a server, the server having a defined studio identification at a second computing device, the server routing the sorted messages to the studio for caching, the cached messages being added to one or more of the remotely located second users' message queues.

In on example, the system further includes: at least one destination user sequentially receives portions of the 65k byte chunks, the chunks being reconstructed. The destination user verifies sound sample rate by comparing the sound sample rate to a predefined sound card sample rate; and if required, correcting the sample rate. The system further includes: creating a temporary way file by dragging the reconstructed sample outside one or more Digital Audio Workstations (DAW)s. A network of the DAWs, creating tracks that are compatible by capturing audio output therefrom and converting sample rate and tempo.

In one example, music sessions are created synchronously and asynchronously either when the first user is alone or in remote or close location with the plurality of second users. The users are musicians.

In another example, the first user shares information and sounds for distribution to one or more second users in real time.

In yet another example, the reconstructed sample is saved on a remote memory. The remote memory is the cloud.

In still another example, up to five users are connected in real time.

In one example, the 65k byte chunk s includes about 1/20 of the original size.

### BRIEF DESCRIPTION OF THE FIGURES

These and other features of that described herein will become more apparent from the following description in which reference is made to the appended drawings wherein:

FIG. 1 is a screenshot of a shared sequencer showing a user action;

FIG. 2 is a log-in screenshot with authentication sequence; and

FIG. 3 is a diagrammatic representation of information flow between servers (scaling from 1 to 10,000 users in real-time and across continents).

### DETAILED DESCRIPTION

### Definitions

Unless otherwise specified, the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present.

Generally speaking, we have developed new and nonobvious systems which address the problems described above.
1. A system that captures the audio output from any DAWs and converts the sample rate so that all tracks are compatible within our environment.
2. A system that allows for synchronous and asynchronous music sessions (users can either play alone within a studio or with other musicians).
3. A system that breaks down the information/sounds shared by a first user so that it can be distributed to a number of participants (remote second users) while maintaining the real-time aspect to it. In one example, if the first user moves a cursor or shares a track using our platform, it will be visible to all participants in real time.

Broadly speaking, an interface and an algorithm where any user can interact as equals within a common interface, regardless of the DAW or the virtual tools they're using. Within this shared environment, up to five users can see each other's cursor move as they add, edit, loop, and delete tracks. This form of real-time collaboration is a hybrid between “synchronous” and “asynchronous”. This hybrid real-time shared environment is not limited to two users like other products on the market. In operation, the users believe they are playing together in the same room and building off of each other's creativity.

Moreover, our platform allows people to play music remotely from the comfort of their home, and within their own creative environment, such as in a home studio. We have created a collaborative environment that fosters creativity as users can build from one another, and it significantly simplifies the post-production process of creating a song. It's simple to use and install as it works with any DAW and any OS. Furthermore, the platform permits global connectivity. All of the musical projects that are created can be saved to the cloud, thereby enabling solo work or group work simultaneously.

In other words, the platform connects users in a shared environment so that they can all play music together without having to take turn producing the final product. Specific uses include, but are not limited to: music creation, remixing of songs and tracks, editing of songs and tracks, looping of songs and tracks, sharing songs and tracks, finalizing production of songs (assembling all different tracks in one final product), and as an ideation and inspiration tool or medium.

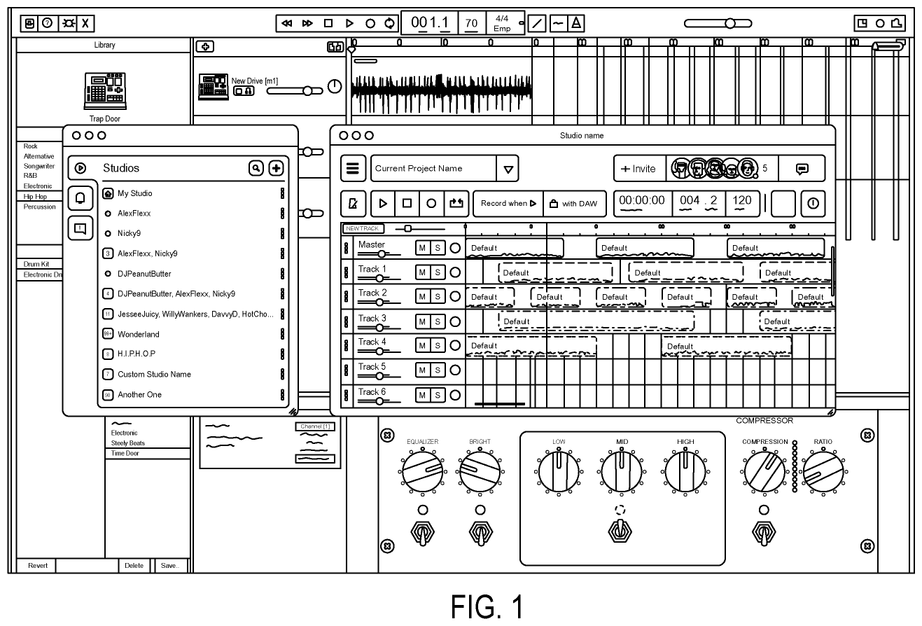

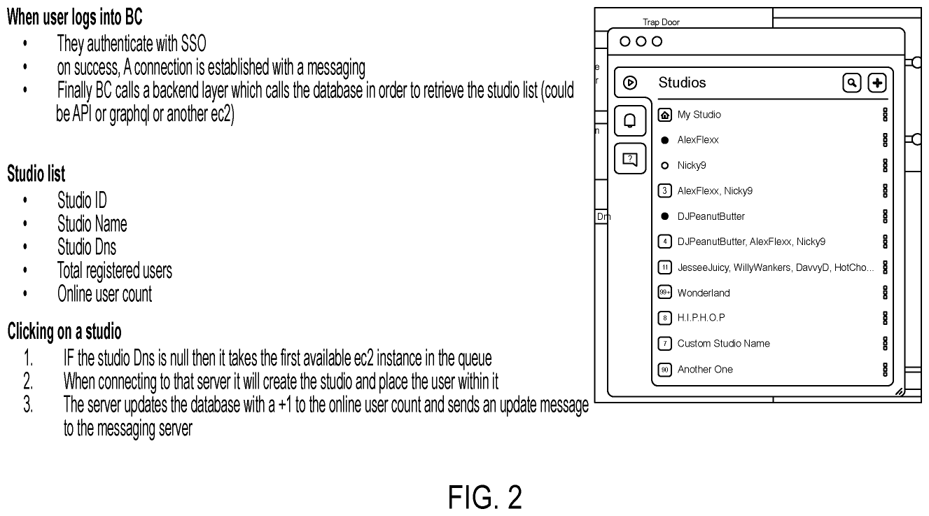

Referring now to FIGS. 1 and 2, our platform is a plugin built using C++™ and is therefore similar to videogame programming. The backend is a Java™ stack running on AWS (Amazon Web Service). Using AWS, all data flowing across the AWS global network that interconnects the datacenters and regions is automatically encrypted at the physical layer. Additional encryption layers exist as well; for example, all VPC cross-region peering traffic, and customer or service-to-service TLS connections.

When using the plugin, all user information is transferred via HTTPS using raw sockets, and account credentials are hashed and salted for maximum security. All sound files and project info are stored in S3 buckets only accessible via services attributed with specific Identity and Access Management (IAM) roles. Finally, all client secrets and other API keys are stored in environment variables and/or key-vaults, on par with industry security standards.

Referring to FIGS. 1 to 3, broadly speaking, the shared environment includes an audio synchronization algorithm in which on a first computing device one or more non-transitory computer-readable storage media encodes computer executable instructions which, when executed by at least one processor, performs a method for connecting a plurality of remotely located users over a shared environment. Broadly speaking, the first computing device can be considered a DAW within a DAW, primarily because the sequencer is part of the device. The method includes the steps of initiating the first computing device and loading, by a first user, a first data sample to a shared sequencer. The following are the steps that follow from the moment a first data sample (a musical track, for example) is shared, up to the point when it is received by one or more users located at a second computing device. The platform loads the first data sequence and then converts it to a base64 string. The base64 string is part of JUCE's library code. A person skilled in the art will recognize that JUCE is a partially open-source cross-platform C++™ application framework, used for the development of desktop and mobile applications. In one example, JUCE is used in particular for its GUI and plug-ins libraries. Furthermore, a person skilled in the art will recognize that JUCE is the name of a coding framework: JUCE is a partially open-source cross-platform C++ application framework, used for the development of desktop and mobile applications.

The first data sample is then compressed (converted) to Free Lossless Audio Codec (FLAC), which is part of JUCE library code.

Thereafter, the base64 string is divided (split) into up to 65k byte chunks with some metadata. This block is 1/20 of its original size (or rounded up to the closest value depending on the original size. This step is based Transmission Control Protocol/Internet Protocol (TCP/IP) messaging protocols

All the received messages are given a priority indicator. The user interactions with the interface, for example, mouse cursor movement and volume adjustments, are generally ranked as “high priority”, whereas sound strings are ranked as “low priority”.

All messages are placed in a queue for the synchronization algorithm code to sort. It should be noted that there are many more variables beyond the prioritization). All messages are then sent to the correct and defined server with the appropriate studio identification (a session between users is called a “studio”).

Once received, the server routes the prioritized message to the studio which caches the data and is then added to each online user's message queue.

Located remotely is one or more destination users who receives the chunks sequentially, bit by bit. Once received, the algorithm reconstructs the data sample. The destination user checks and compares the sample rate of the sound against their soundcard's predetermined sample rate. If there's a difference, the algorithm then converts the sample to the correct sample rate, completely eliminating any playback and creative issue between multiple users. In one example, some JUCE code may be used to help with the interpolation of samples. A temporary way file (Waveform Audio File Format, which is an audio file format standard, developed by IBM™ and Microsoft™, for storing an audio bitstream on PCs) is used for dragging samples outside the digital audio workstation (DAW) is then created once the sample is reconstructed. As noted above, there is some JUCE code to help with the interpolation of samples.

In summary, the platform captures the audio output from any DAWs and convert the sample rate and the tempo (bpm) so that all tracks are compatible. It allows for synchronous and asynchronous music sessions, in which the users can either play alone within a studio or with other musicians). It also breaks down the information/sounds shared by a user so that it can be distributed to all participants (other remotely located users), all of which is carried out in real-time.

By having the information parced and shared in the cloud, it removes the need to establish a fixed connection between one or multiple users (synchronous). Instead, one only needs to connect to a studio (hosted in the cloud) and pick up where it was last left at.

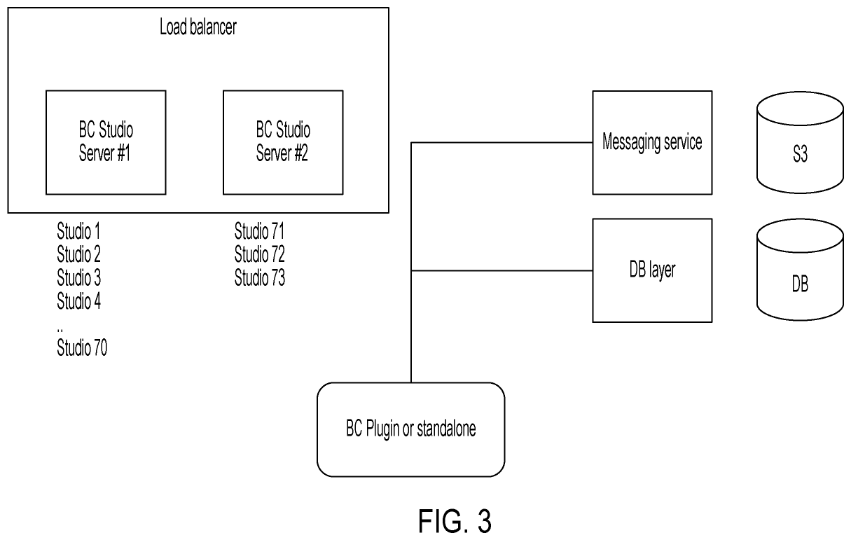

In the examples specifically shown in FIGS. 2 and 3, the first user logs into the platform and their identity is authenticated with SSO. After successful authentication, a connection is established with messaging. Finally, the platform contacts a backend layer, which in turn calls the database to retrieve the studio list. In one example, the studio list can be API, graphqi, or another ec2. The studio list includes a studio ID; a studio name; a studio dns; total number of registered users; and the online user count. When the user clicks on a studio (selects), if the studio Dns is null, then it takes the first available ec2 instance in the queue. When connecting to that selected server, it will create the studio and place the user in it. Thereafter, the server then updates the database with a +1 to the online user counter, and sends an update message to the messaging server.

### OTHER EMBODIMENTS

From the foregoing description, it will be apparent to one of ordinary skill in the art that variations and modifications may be made to the embodiments described herein to adapt it to various usages and conditions.

What is claimed is:

1. A method for connecting a plurality of remotely located users over a shared environment, the method comprising:
a) loading, by a first user, a first data sample to a shared sequencer;
b) converting the first data sample to a base64 string, the base64 string being part of a JUCE library code;
c) converting the converted first data sample to a compressed data sample;
d) generating a plurality of messages by splitting the compressed data sample into 65k byte chunks having therein a portion of metadata;
e) prioritizing the messages from low priority to high priority and queuing the prioritized messages for sorting; and
f) sending the sorted messages to a server, the server having a defined studio identification, the server routing the sorted messages to the studio for caching, the cached messages being added to one or more of the remotely located second users' message queues.

2. The method, according to claim 1, further includes: at least one destination user sequentially receives portions of the 65k byte chunks, the chunks being reconstructed.

3. The method, according to claim 2, in which:
a) the destination user verifies sound sample rate by comparing the sound sample rate to a predefined sound card sample rate; and
b) if required, correcting the sample rate.

4. The method, according to claim 3, further includes: creating a temporary way file by dragging the reconstructed sample outside one or more Digital Audio Workstations (DAW)s.

5. The method, according to claim 4, in which, in a network of the DAWs, creating tracks that are compatible by capturing audio output therefrom and converting sample rate and tempo.

6. The method, according to claim 1, in which music sessions are created synchronously and asynchronously either when the first user is alone or in remote or close location with the plurality of second users.

7. The method, according to claim 6, in which the users are musicians.

8. The method, according to claim 1, in which the first user shares information and sounds for distribution to one or more second users in real time.

9. The method, according to claim 1, in which the reconstructed sample is saved on a remote memory.

10. The method, according to claim 9, in which the remote memory is the cloud.

11. The method, according to claim 1, in which up to five users are connected in real time.

12. The method, according to claim 2, in which the 65k byte chunks includes about 1/20 of the original size.

13. One or more non-transitory computer-readable storage media encoding computer executable instructions which, when executed by at least one processor, performs a method for connecting a plurality of remotely located users over a shared environment, the method comprising:
initiating a first computing device and loading, by a first user, a first data sample to a shared sequencer;
converting the first data sample to a base64 string, the base64 string being part of a JUCE library code;
converting the converted first data sample to a compressed data sample;
generating a plurality of messages by splitting the compressed data sample into 65k byte chunks having therein a portion of metadata;
prioritizing the messages from low priority to high priority and queuing the prioritized messages for sorting; and
sending the sorted messages to a server, the server having a defined studio identification at a second computing device, the server routing the sorted messages to the studio for caching, the cached messages being added to one or more of the remotely located second users' message queues

14. The non-transitory computer-readable storage media, according to claim 13, further includes: at least one destination user sequentially receives portions of the 65k byte chunks, the chunks being reconstructed.

15. The non-transitory computer-readable storage media, according to claim 14, in which:
the destination user verifies sound sample rate by comparing the sound sample rate to a predefined sound card sample rate; and
if required, correcting the sample rate.

16. The non-transitory computer-readable storage media, according to claim 15, further includes: creating a temporary way file by dragging the reconstructed sample outside one or more Digital Audio Workstations (DAW)s.

17. The non-transitory computer-readable storage media, according to claim 14, in which, in a network of the DAWs, creating tracks that are compatible by capturing audio output therefrom and converting sample rate and tempo.

18. The non-transitory computer-readable storage media, according to claim 13, in which music sessions are created synchronously and asynchronously either when the first user is alone or in remote or close location with the plurality of second users.

19. The non-transitory computer-readable storage media, according to claim 13, in which the users are musicians.

20. The non-transitory computer-readable storage media, according to claim 13, in which the first user shares information and sounds for distribution to one or more second users in real time.

21. The non-transitory computer-readable storage media, according to claim 13, in which the reconstructed sample is saved on a remote memory.

22. The non-transitory computer-readable storage media, according to claim 21, in which the remote memory is the cloud.

23. The non-transitory computer-readable storage media according to claim 13, in which up to five users are connected in real time.

24. The non-transitory computer-readable storage media, according to claim 14, in which the 65k byte chunks include about 1/20 of the original size.

25. A system comprising:
one or more processors; and
a memory coupled to the one or more processors, the memory for storing instructions which, when executed by the one or more processors, cause the one or more processors to perform a method for connecting a plurality of remotely located users over a shared environment, the method comprising, the method comprising:
initiating a first computing device and loading, by a first user, a first data sample to a shared sequencer;
converting the first data sample to a base64 string, the base64 string being part of a JUCE library code;
converting the converted first data sample to a compressed data sample;
generating a plurality of messages by splitting the compressed data sample into 65k byte chunks having therein a portion of metadata;
prioritizing the messages from low priority to high priority and queuing the prioritized messages for sorting; and
sending the sorted messages to a server, the server having a defined studio identification at a second computing device, the server routing the sorted messages to the studio for caching, the cached messages being added to one or more of the remotely located second users' message queues.

26. The system, according to claim 25, further includes: at least one destination user sequentially receives portions of the 65k byte chunks, the chunks being reconstructed.

27. The system, according to claim 26, in which: the destination user verifies sound sample rate by comparing the sound sample rate to a predefined sound card sample rate; and if required, correcting the sample rate.

28. The system, according to claim 27, further includes: creating a temporary way file by dragging the reconstructed sample outside one or more Digital Audio Workstations (DAW)s.

29. The system, according to claim 27, in which, in a network of the DAWs, creating tracks that are compatible by capturing audio output therefrom and converting sample rate and tempo.

30. The system, according to claim 25, in which music sessions are created synchronously and asynchronously either when the first user is alone or in remote or close location with the plurality of second users.

31. The system, according to claim 30, in which the users are musicians.

32. The system, according to claim 25, in which the first user shares information and sounds for distribution to one or more second users in real time.

33. The system, according to claim 25, in which the reconstructed sample is saved on a remote memory.

34. The system, according to claim 33, in which the remote memory is the cloud.

35. The system, according to claim 25, in which up to five users are connected in real time.

36. The system, according to claim 26, in which the 65k byte chunks includes about 1/20 of the original size.
